(19) United States
(12) Patent Application Publication
(10) Pub. No.: US 2005/0223764 A1
(43) Pub. Date: Oct. 13, 2005

(54) Retaining mechanism for mortise cylinders

(75) Inventors: Josh Pierson, Golden, CO (US); Gilbert Lombardo, San Marcos, TX (US)

Correspondence Address: STORM L.L.P., BANK OF AMERICA PLAZA, 901 MAIN STREET, SUITE 7100, DALLAS, TX, 75202, US

(73) Assignee: Detex Corporation, New Braunfels, TX (US)

(21) Appl. No.: 11/098,987

(22) Filed: Apr. 5, 2005

Related U.S. Application Data
(60) Provisional application No. 60/560,651, filed on Apr. 8, 2004.

(51) Int. Cl. E05B 63/14; E05B 9/04

(52) U.S. Cl. 70/370; 70/371

(57) ABSTRACT

A mortise cylinder has a longitudinal axis and an exterior surface. A collar member has an internal dimension or diameter that is adapted to receive the mortise cylinder in close sliding relation. A locking member is adapted to surround the collar member about the exterior surface of the mortise cylinder, wherein the mortise cylinder is secured against axial movement relative to the collar. The collar is less rigid than the exterior surface of the mortise cylinder. According to the preferred embodiment of the present invention, the collar member is formed integrally with a cover that secures the lock assembly to a door.

### CLAIM OF PRIORITY

This application claims priority to U.S. Provisional Patent Application No. 60/560,651 filed on Apr. 8, 2004, on behalf of Josh Pierson and Gilbert Lombardo, entitled “Locking Mechanism for Mortise Lock Device,” filed on Apr. 8, 2004, and which is hereby incorporated by reference for all purposes.

### CROSS-REFERENCES TO RELATED APPLICATIONS

This application is also related to co-pending U.S. patent application entitled “Self-Adjusting Cam Assembly,” which claims priority to U.S. Provisional Patent Application No. 60/560,809, filed on Apr. 8, 2004.

### FIELD OF THE INVENTION

The present invention relates generally to lock assemblies or alarm mechanisms in which a keyed or mortise cylinder is employed. More particularly, the present invention relates to a novel assembly for securing a mortise cylinder in an alarm housing or cover plate.

### BACKGROUND OF THE INVENTION

Commonly, door locks, exit alarms, panic devices, and other locking systems employ mortise cylinders that typically are operated with a key (a keyed cylinder). Such assemblies often are installed on a wall or a door. To minimize the size, lock and alarm assemblies must be compact. This introduces a number of difficulties in the design and assembly of such devices.

Typically, an alarm or lock assembly comprises a plate that covers the alarm or lock and the mortise cylinder disposed therein. A bracket is secured to the interior of the plate. The bracket and plate cooperate to form a housing for the mortise cylinder and alarm. Typical mounting of the housing is achieved with mounting screws. The mortise cylinder is commonly secured to the bracket by a hexagonal nut engaging threads formed on the exterior of the cylinder. Keys and corresponding key ways, as well as setscrews, are methods of securing the mortise cylinder to the housing to prevent rotation of the mortise cylinder.

During installation and assembly, installing the hex nuts, set screws, or keys can be a difficult process in the close space. Additionally, the multiple nuts and screws required for these assemblies increase cost, the potential for lost or unavailable parts, and generally increases the complexity, time, and ultimately cost of installation.

Throughout the years there have been many attempts to improve locking and alarm mechanisms for doors. These attempts have involved varying the configuration of mortise cylinders, plates, brackets, and so forth. Some examples of these attempts are listed below.

U.S. Pat. No. 4,522,048 issued to Davis (“Davis”), relates to locking devices that provide security against unauthorized entries, in particular to locks and door reinforcing plate means. It discloses a lock having a mortise cylinder secured to a reinforcing plate device designed to resist punching of the mortise cylinder into or through a door. The plate device consists of a first and second plate adapted to be disposed against the opposite faces of the door in substantial mutual alignment, with a tube rigidly secured to the inner face of the first plate, extending through the door towards the second plate. The mortise cylinder is disposed against the outer face of the first plate and extends into the interior of the tube means to connect with the second plate in an operable engagement between the plates and the mortise cylinder. The disclosure of the Davis provides for a set of plates connected through the tube to secure the mortise cylinder.

U.S. Pat. No. 4,930,822 issued to Shen (“Shen”), discloses a retention plate assembly for retaining a lock in a wooden door or a metallic door having a cylindrical bore for receiving the lock. The retention plate is planar with a central cutout forming a pair of opposed inwardly extending protuberances adapted for engagement within corresponding recesses formed on the lock. This retention plate, in connection with the lock, or the housing of the lock, firmly retains the lock in position. Furthermore, the complete assembly is held in place through sets of tabs in the plate engaged with slots formed on opposite sides of the door bore.

U.S. Pat. No. 3,503,233 issued to Russell, et al. (“Russell”), discloses a retaining plate for anchoring a lock assembly on a door having a mounting opening. The lock assembly has a partially threaded lock housing adapted for mounting in the opening, and a fastening nut for engaging the threaded housing so as to clamp the lock assembly between the faces of the door. The plate is disposed between one face of the door and the fastening nut to prevent the nut from loosening and allowing the lock assembly to rotate in the mounting. Specifically, Russell claims a plate with protruding tabs in engagement with cutouts in the door to hold the lock assembly in place.

U.S. Pat. No. 1,838,333 issued to Stone (“Stone”), discloses a fastener for securing a key cylinder in place. This fastener consists of a disk-shaped plate having a hole adapted to fit the cylinder in such a way to prevent the cylinder from turning independently of the plate. A holder engages with a projecting end of the cylinder, a threaded screw engages with the cylinder to secure it in place, and a nut engages with the screw threaded end of the cylinder to adapt and press the cylinder against the plate.

U.S. Pat. No. 3,899,907 issued to Prahl (“Prahl”), discloses a cylinder lock assembly having a cylinder lock, an externally threaded housing, an internally threaded adjustable extension for adjusting the length of the housing to the width of the door in which the lock assembly is to be installed. It also provides for a door plate that covers the front surface of the housing and that has an aperture in alignment with the keyhole for insertion and rotation of the key.

U.S. Pat. No. 6,502,436 B2 issued to Beatty (“Beatty”), discloses a cylindrical shell for a deadbolt designed to protect a deadbolt assembly from tampering. It consists of a first and second housing members adapted to be in proximity to an outside face and an inside face, respectively, of the door. A deadbolt actuating mechanism is disposed in a cavity in the door between the first and second housing members to allow the deadbolt to reciprocate between an extended and a retracted position. A pair of oppositely oriented cylindrical shells surrounds the deadbolt actuating mechanism to prevent tampering.

U.S. Pat. No. 4,679,418 issued to Allen (“Allen”), discloses a high security cylinder operated lock. It consists of a lock housing extending transversely through a door and encompassing the lock operating cylinder and the bolt moving mechanism of the lock. The lock bolt has a drill resistant guard plate mounted in the housing to protect the mortise cylinder against drilling, and it is adapted to accommodate a rotatable disk having a key slot.

U.S. Pat. No. 4,297,862 issued to Solovieff (“Solovieff”), discloses a lock mechanism with removable cylinder holder such that it can be readily modified to be operated by a variety of keys. The mortise cylinder is mounted in a holder that is releasably inserted in a mounting structure secured to the door. A retaining mechanism accessible from an edge of the door secures the holder when the door is closed, and releases the holder when the door is open. This retaining mechanism has a movable latch member that is moved to a release position when the door is open, to allow for removal of the holder and the cylinder.

U.S. Pat. No. 1,629,172 issued to Murphy (“Murphy”), discloses a lock mechanism that provides means to prevent the lock from being forced by furtive bodily rotation of its cylinder from the exposed front end. Murphy consists of an externally threaded cylinder lock, for insertion into a door from the outside, and has one or more longitudinal grooves; and an internally threaded housing, for insertion into the door from the inside, having similar longitudinally grooves. One disadvantage of Murphy, however, is that the mechanism is not characterized by thread-like features strong enough to create a “compression fit” resembling spring-like capturing forces.

U.S. Patent Application Publication U.S. 2002/0026817 A1 by Greer (“Greer”), discloses an assembly and method for installing a cylinder lock. The assembly is characterized by a mounting member with a defined opening, and an adapter having an internal bore designed to receive the cylinder lock. The adapter has several outwardly extending projections and the mounting member has latch members adapted to inter-engage the projections.

Each attempt made at improving the use of mortise cylinders in alarms has been fraught with both advantages and drawbacks. Installing mortise cylinders in alarms is especially difficult when access is limited. No attempt, thus far, has adequately resolved the issues of the time and difficulty associated with installation. These issues result in an increased cost of installation. Accordingly, a need exists for a method of securing the mortise cylinder in an alarm assembly that can be easily accomplished in confined installation space, reducing the time, complexity, and ultimate cost of the installation.

### SUMMARY OF THE INVENTION

It is a general object or aspect of the present invention to provide an improved and simplified design and method for installation of a mortise cylinder in an alarm system mounted on a door or wall. This object or aspect of the invention is achieved by providing a mortise cylinder that has a longitudinal axis and an exterior surface. A collar member has an internal dimension or diameter that is adapted to receive the mortise cylinder in close sliding relation. A locking member is adapted to surround the collar member about the exterior surface of the mortise cylinder, wherein the mortise cylinder is secured against axial movement relative to the collar.

According to the preferred embodiment of the present invention, the collar is less rigid than the exterior surface of the mortise cylinder.

According to the preferred embodiment of the present invention, the collar member is formed integrally with a plate or cover that secures the alarm assembly to a door.

According to the preferred embodiment of the present invention, a key way is formed in the exterior surface of the mortise cylinder and parallel to its longitudinal axis and a corresponding key member or lug is formed in the locking member, the key member for registry with the key way to secure the mortise cylinder against rotational movement relative to the locking member.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

FIG. 1 is an elevation view of a door and wall incorporating an alarm assembly according to the preferred embodiment of the present invention.

FIG. 2 is an exploded perspective view of the alarm assembly of FIG. 1.

FIG. 3 is an enlarged view of the alarm assembly of FIG. 2, illustrating the plate and collar member of the lock assembly of the preferred embodiment of the present invention.

FIG. 4 is a cross-sectional view of the alarm assembly of the preferred embodiment of the present invention.

FIG. 5 is an enlarged section view of the alarm assembly of FIG. 4, illustrating the engagement between the collar member, mortise cylinder, and locking member.

### DETAILED DESCRIPTION OF THE PREFERRED EMBODIMENTS

In the following discussion, numerous specific details are set forth to provide a thorough understanding of the present invention. However, it will be obvious to those skilled in the art that the present invention may be practiced without such specific details. In other instances, well-known elements have been illustrated in block diagram form in order not to obscure the present invention in unnecessary detail.

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

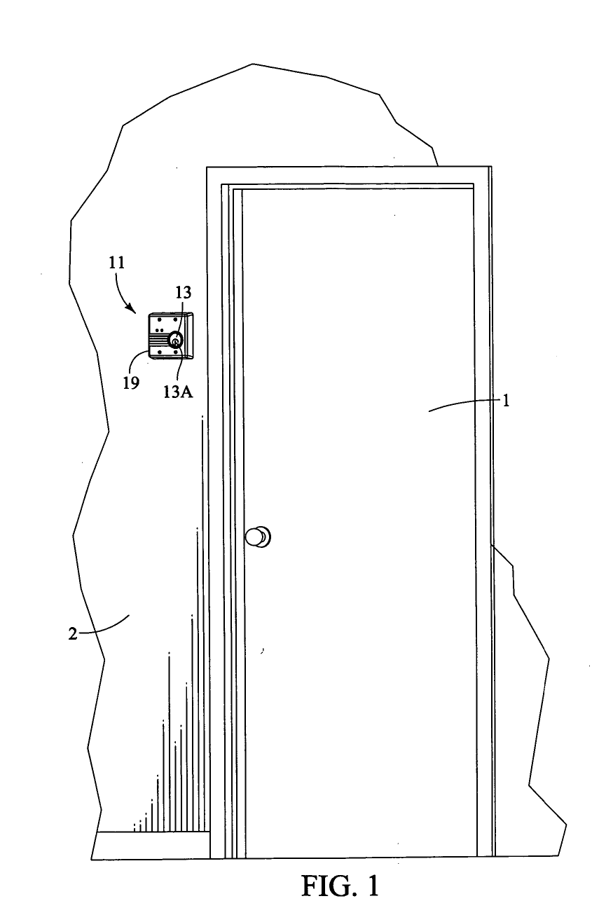

FIG. 1 of the drawings is an elevation view of a door 1 incorporating a wall 2 mounted alarm assembly 11 according to the preferred embodiment of the present invention. Alarm assembly 11 is secured onto wall 2, allowing door 1 to be alarmed. Alarm assembly 11 comprises a plate or cover 19 having attached thereto a mortise cylinder 13. Mortise cylinder 13 further comprises a rotatable key cylinder 13A. An alarm 3 (not shown) is secured under cover 19 when fully assembled, to prevent unauthorized tampering with alarm 3 and to prevent environmental exposure of alarm 3. Door 1 may be alarmed or disarmed by inserting and rotating a proper key 43 in key cylinder 13A of mortise cylinder 13.

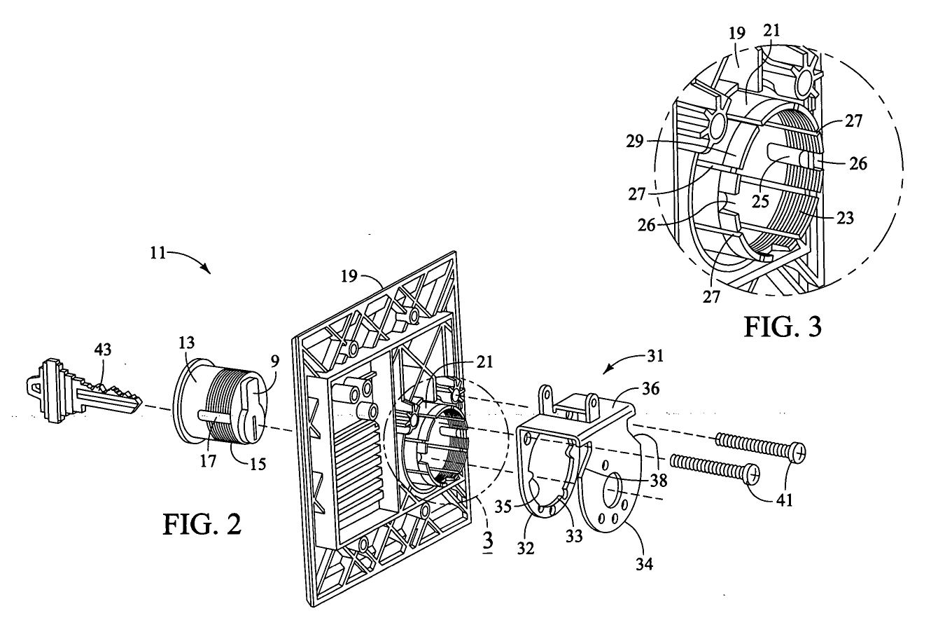

Referring to FIG. 2 of the drawings, a more detailed depiction of components of alarm assembly 11 is illustrated. Specifically, mortise cylinder 13, key cylinder 13A, key 43, cover 19, and bracket 31 are shown. The outer perimeter of mortise cylinder 13 includes external threads 15 and key ways or slots 17 extending along at least a portion of the outer perimeter of mortise cylinder 13. Cover 19 includes a collar 21 to engage mortise cylinder 13. Alarm (not shown) is mounted to the interior of cover 19.

As can best be seen in FIG. 3, collar 21 includes several features of a preferred embodiment of the present invention. Collar 21 comprises chamfers 29 and slots 27 along the perimeter of collar 21. Internal threads 23 for receiving external threads 15 of mortise cylinder 13 are formed on the interior surface of collar 21. The disclosed embodiment of collar 21 provides engagement of internal threads 23 with external threads 15 of mortise cylinder 13 to provide longitudinal (back and forth) support for mortise cylinder 13. In an alternative embodiment not illustrated, collar 21 incorporates a plurality of ridges 23 adapted for complementary engagement with externally threads 15 of mortise cylinder 13.

As can best be seen in FIG. 3, at least one key 25 is located on the interior surface of collar 21. In the preferred embodiment, a pair of keys 25 are located on the interior surface of collar 21. The disclosed embodiment of collar 21 provides engagement of keys 25 with slots 17 on mortise cylinder 13 prevents rotation of mortise cylinder 13 relative to cover 19.

Collar 21 has a substantially circular cross-section and a tapered inside diameter to facilitate complementary reception of mortise cylinder 13. At the front of cover 19, the inside diameter of collar 21 may be at least as large as, or slightly larger than, the outside diameter of mortise cylinder 13, so that external threads 15 of mortise cylinder 13 can initially be inserted easily into collar 21. From that opening, the inside diameter of collar 21 tapers so that, at its smallest diameter, it is smaller than the outer diameter or external dimension of mortise cylinder 13, resulting in a diametrically increasing interference fit with increasing axial co-alignment of mortise cylinder 13 and collar 21.

Slots 27 permit diametrical expansion of collar 21 when mortise cylinder 13 is pressed further into position inside collar 21. This permits insertion of mortise cylinder 13 into cover 19 without rotational threading. If collar 21 is tapered, a radial compressive force is applied to mortise cylinder 13 that assists in maintaining the alignment and azimuthal position of mortise cylinder 13 when engaged in collar 21. The compressive forces of collar 21 on mortise cylinder 13, combined with the engagement of external threads 15 with internal threads 23, provide resistance to axial movement. However, slots 27 may again permit diametrical expansion of collar 21 and allow removal of mortise cylinder 13 without bracket 31.

As can be seen in FIG. 2, bracket 31 is provided to maintain the position of mortise cylinder 13 when engaged in collar 21, and simultaneously prevent rotation of mortise cylinder 13 relative to cover 19. In the preferred embodiment, bracket 31 is very generally U-shaped, and comprises a front 32, a back 34, and a connective top 36. Front 32 is located near to cover 19. Front 32 includes an aperture 33 adapted to receive collar 21. Aperture 33 fits over chamfers 29 of collar 21. Within aperture 33 are lugs 35 protruding toward the center of aperture 33. Lugs 35 are adapted to fit in to pair of lug slots 26. Lugs 35 may also engage slots 17 on mortise cylinder 13.

Back 34 of bracket is connected to front 32 by top 36. Back 34 is spaced apart from 31 for receiving a cam, which is not shown. An example of the cams relationship to alarm assembly 11 can be found thoroughly described in related and co-pending U.S. patent application entitled “Self-Adjusting Cam Assembly,” which claims priority to U.S. Provisional Patent Application No. 60/560,809.

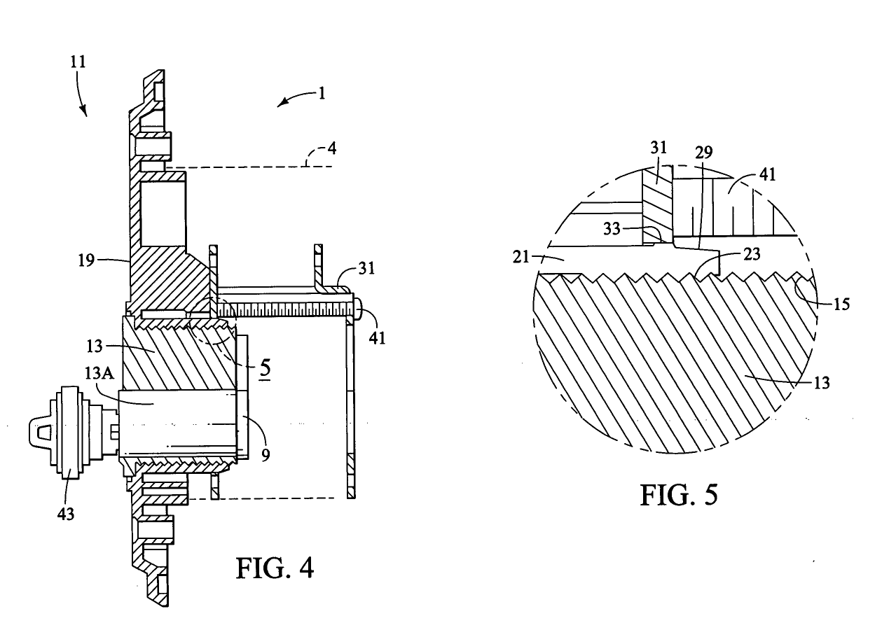

In the preferred embodiment, back 34 and front 32 have holes, slots, or other relief's 38 for receiving screws 41. As can be seen in FIG. 2, aperture 33 and lugs 35 provide easy location and positioning of bracket 31 relative to cover 19. As can be seen in FIGS. 4 and 5, screws 41 secure the position of bracket 31 in relation to cover 19. When mortise cylinder 13 is pushed into collar 21, external threads 15 couple to internal threads 23 providing longitudinal support for mortise cylinder 13. When bracket 31 is attached to cover 19, aperture 33 prohibits diametrical expansion of collar 21, prohibiting disengagement of external threads 15 from internal threads 23, and thus prohibiting removal of mortise cylinder 13. Lugs 35 may optionally couple to slots 17 so that mortise cylinder 13 is further restricted from rotation.

The lock assembly has a number of advantages over the prior art. Specifically, it reduces the number of parts in the assembly, eliminates time consuming threading of mortise cylinder 13 into cover 19, and simplifies the overall assembly of components in a manner that is especially valuable when incorporating conventional mortise cylinders 13 in alarm assemblies 11.

### Operation of the Preferred Embodiments

Much of the operation of the preferred embodiments have been described above. Referring again to the Figures, and particularly to FIG. 1, an elevation view of a door 1 incorporating an alarm assembly 11 according to the present invention is illustrated. The only portions of alarm assembly 11 visible in FIG. 1 are the end of mortise cylinder 13 and cover 19. Cover 19 is part of alarm assembly 11 but also serves a “cosmetic” purpose in that it covers the alarm 3. According to the preferred embodiment of the present invention, alarm assembly 11 has utility in connection with conventional door locks, exit control locks, exit alarms, panic devices, and the like where conventional mortise cylinders (keyed or otherwise) are used.

With reference to FIG. 2, an exploded view of alarm assembly 11, without door 1 and wall 2, is shown. As can be seen, alarm assembly 11 preferably comprises a conventional mortise cylinder 13, which has a rotatable key cylinder 13A, on its exterior end, and a tailpiece 9 on its opposite end. Conventional mortise cylinder 13 has external threads 15 along at least a portion of its exterior surface. Mortise cylinder 13 further provides slots 17 (one of which is obscured from view) that are aligned with the longitudinal axis of mortise cylinder 13.

Although the term “cylinder” is used, and the majority of mortise cylinders are cylindrical, the cylinder according to the present invention need not be cylindrical in configuration. Similarly, while a keyed mortise cylinder (operated with a key) is illustrated, the present invention has utility with non-keyed lock assemblies. Within the interior of mortise cylinder 13 (not shown), there may be tumblers or other conventional locking devices, which exist in or act in mechanical cooperation with key cylinder 13A. Key cylinder 13A is rotatable in response to actuation by key 43 or by a knob.

Alarm assembly 11 employs a collar 21 for receiving cylinder 13. FIG. 3 is an enlarged view of collar 21, which is formed integrally with cover 19. Collar 21 has a substantially circular cross-section and can have a slightly tapered internal dimension or inside diameter. At the front of cover 19, the opening in collar 21 may be as large as, or slightly larger than, the diameter of the exterior surface of mortise cylinder 13, so that mortise cylinder 13 can be inserted easily into collar 21. From that opening, the inside diameter or dimension of collar 21 can taper so that, at its smallest diameter, it is slightly smaller than the outer diameter or external dimension of mortise cylinder 13. Thus, a compressive, or squeezing force is applied to mortise cylinder 13 to assist in maintaining the azimuthal position of mortise cylinder 13 when engaging collar 21.

To create efficient and secure engagement of mortise cylinder 13, collar 21 incorporates a variety of other features. The interior surface of collar 21 comprises internal threads 23 designed to couple with external threads 15 of mortise cylinder 13. Additionally, a pair of keys 25 are formed in the interior of collar 21 to register with slots 17 in mortise cylinder 13, providing immediate and efficient alignment of mortise cylinder 13 relative to collar 21 and cover 19 upon assembly as shown in FIG. 4. Collar 21 is also provided with a plurality of slots 27 equally spaced about its circumference to allow diametrical expansion of collar 21 to accommodate the exterior of mortise cylinder 13. Chamfers 29 can also be provided to ease the fit of bracket 31 over collar 21.

Accordingly, mortise cylinder 13 may be inserted into collar 21 with relative ease, and without the need to rotate mortise cylinder 13 numerous full revolutions. Once it is fully inserted, the increasing interference fit between the inner diameter of collar 21 and the outer diameter of mortise cylinder 13, combined with the engagement of external threads 15 and internal threads 23, secure mortise cylinder 13 against longitudinal movement within and relative to collar 21 and cover 19.

Referring to FIGS. 2 and 4, a bracket 31, which is preferably U-shaped, is provided. Bracket 31 defines a locking member having a front 32 with an aperture 33 adapted to receive collar 21 upon assembly. Lugs 35 are formed in the aperture to register with lugs slots 26 in collar 21 and also with and key ways 17 in mortise cylinder 13. This engagement combination secures mortise cylinder 13 against rotation relative to bracket 31, collar 21, and cover 19. Upon assembly, a pair of screws 41 secure bracket 31 to cover 19 and, as explained above and will be explained in detail with reference to FIG. 5, secure mortise cylinder 13 against axial and rotational movement relative to cover 19, collar 21, and bracket 31.

Although not shown for clarity, bracket 31 also fixes a cam in engagement with tailpiece 9 at the end of mortise cylinder 13 so that a lock bolt or alarm can be activated by the turning key cylinder 13A contained within mortise cylinder 13, whether by key 43 or other means such as a knob. An example of such a cam assembly is commonly assigned co-pending U.S. patent application entitled “Self-Adjusting Cam Assembly,” which claims priority to U.S. Provisional Patent Application No. 60/560,809, filed on Apr. 8, 2004.

As shown in FIG. 5, upon assembly, the front 32 of bracket 31 having aperture 33 is slid over the chamfer 29 portion of collar 21 while mortise cylinder 13 is disposed in collar 21. Screws 41 are employed to secure bracket 31 to plate or cover 19 and over collar 21. In a preferred embodiment, as screws 41 are tightened, bracket 31 is drawn towards cover 19. As this occurs, aperture 33 is drawn against the increasing outside diameter of chamfer 29 of collar 21, forming an interference fit. Collar 21 is formed of a material less rigid than bracket 31 and mortise cylinder 13. The lack of rigidity is enhanced by the presence of slots 27. After mortise 13 is pressed into collar 21, bracket 31 prohibits subsequent diametrical expansion of collar 21 thereby preventing disengagement of external threads 15 from internal threads 23.

Thus, external threads 15 and internal threads 23 formed on mortise cylinder 13 and collar 21 respectively provided mechanical engagement, thereby securing mortise cylinder 13 against longitudinal (back and forth) movement within and relative to collar 21, bracket 31, and cover 19. As previously stated, engagement between keys 25 and key ways 17, and/or between lugs 35 on bracket 31 and key ways 17 on mortise cylinder 13 secures mortise cylinder 13 against rotational movement relative to collar 21, bracket 31, and plate or cover 19.

According to the preferred embodiment of the present invention, collar 21 and its various features are molded integrally as a part of cover or plate 19. Cover 19 is preferably a molded of a plastic resin or relatively lightweight metal in compliance with relevant building codes. Except as described herein, cover 19 is conventional in construction.

Commonly, mortise cylinders are provided with threads on the exterior surface and key ways for use in conventional assemblies employing set screws and/or hex nuts. Accordingly the present invention is adapted for use with conventional mortise cylinders. Bracket 31 is preferably constructed of galvanized steel and must be sufficiently heavy, and collar 21 sufficiently light (in material or construction or both), such that mortise cylinder 13 is capable of diametrically expanding collar 21 around its exterior, while bracket 31 is strong enough to prohibit diametrical expansion of collar 21 when attached to cover 19.

Alarm assembly 11 has a number of advantages over the prior art. It reduces the number of parts in the assembly and simplifies the assembly of components in a manner that is especially valuable when installing conventional mortise cylinders into alarm assemblies.

The invention has been described with reference to preferred embodiments thereof, it is thus not limited, but susceptible to variation and modification without departing from the scope and spirit of the invention.

Having thus described the present invention by reference to certain of its preferred embodiments, it is noted that the embodiments disclosed are illustrative, rather than limiting in nature, and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments. Accordingly, it is appropriate that the appended claims be construed broadly and in a manner consistent with the scope of the invention.

1. An alarm assembly comprising:
a mortise cylinder having an externally threaded surface;
a cover comprising a collar that is diametrically expandable for receiving the mortise cylinder;
the collar having an internally threaded surface adapted for threaded engagement with the externally threaded surface of the mortise cylinder;
a locking member attachable to the cover to prohibit diametrical expansion of the collar.

2. The alarm assembly according to claim 1, wherein the collar member is formed integrally with the cover.

3. The alarm assembly according to claim 1, further comprising:
a plurality of longitudinal slots formed on the collar.

4. The alarm assembly according to claim 1, further comprising:
a key way formed in the exterior surface of the mortise cylinder parallel to its longitudinal axis; and
a key formed on the internally threaded surface of the collar engageble with the key way.

5. The alarm assembly according to claim 1, further comprising:
a key way formed in the exterior surface of the mortise cylinder parallel to its longitudinal axis; and
a lug formed on the locking member, engageble with the key way.

6. The alarm assembly according to claim 1, further comprising:
a lug slot formed on the collar; and
a lug formed on the locking member, engageble with the lug slot.

7. The alarm assembly according to claim 1, wherein the collar has an internal diameter smaller than an external diameter of the mortise cylinder, wherein the interference fit diametrically expands the collar about the exterior surface of the mortise cylinder.

8. The alarm assembly according to claim 1, wherein the locking member further comprises;
a bracket having a front portion with an aperture which circumferentially surrounds the collar to prevent diametrical expansion of the collar.

9. The alarm assembly according to claim 8, wherein the collar further comprises;
a chamfered portion for receiving the aperture of the bracket.

10. The alarm assembly according to claim 8, wherein the collar further comprises;
a chamfered portion for receiving the aperture of the bracket.

11. An alarm assembly comprising:
a mortise cylinder having an externally threaded surface;
a cover comprising a collar that is diametrically expandable for receiving the mortise cylinder;
the collar having a ridges adapted for complementary engagement with the externally threaded surface of the mortise cylinder;
a locking member attachable to the cover to prohibit diametrical expansion of the collar.
